(19) United States
(12) Patent Application Publication
(10) Pub. No.: US 2004/0065417 A1
(43) Pub. Date: Apr. 8, 2004

(54) Sound-attenuation system for a window shade

(76) Inventor: Leah J. Vanpoelvoorde, Glendale, AZ (US)

Correspondence Address: STONEMAN LAW OFFICES, LTD, 3113 NORTH 3RD STREET, PHOENIX, AZ, 85012, US

(21) Appl. No.: 10/678,349

(22) Filed: Oct. 3, 2003

Related U.S. Application Data
(60) Provisional application No. 60/416,984, filed on Oct. 8, 2002.

(51) Int. Cl. E06B 3/48

(52) U.S. Cl. 160/84.05

(57) ABSTRACT

A system for improved shading of the interior of a building, more specifically, a shade system for use over a window in a door or in a window frame. The system comprises a window shade having a bottomrail, and an impact-absorbing cushion for the bottomrail for quieting potential impacts of the bottomrail with surrounding window structures. The system provides both a passive method of quieting a window shade, and a passive method of reducing impact of a bottomrail against adjacent window structures, while not restricting the position of the shade. A kit and business methods are also disclosed.

### CROSS-REFERENCE TO RELATED APPLICATION

The present application is related to prior provisional application Serial No. 60/416,984, filed Oct. 8, 2002, entitled “SOUND-ATTENUATION SYSTEM FOR A WINDOW SHADE”, the contents of which are incorporated herein by this reference and are not admitted to be prior art with respect to the present invention by the mention in this cross-reference section.

### BACKGROUND

This invention relates to providing a sound-attenuation system attachable to a bottomrail of a window shade for reducing the noise associated with a swinging shade impacting the surrounding window frame structure. More particularly, this invention concerns such a system for users who do not want to have to fix the bottomrail against the window sill or other adjacent structure each time they adjust the shade.

Typically, window shades may be set in motion by wind through an open window, by adjustment of the shade, or by motion of a door to which they are attached. This can create an unpleasant noise as the shades swing against the window pane, framing members or other adjacent structure. Furthermore, this can result in scratching or marring of the surrounding structure.

To compensate for the above-stated condition, a person may fix the bottomrail of a window shade to the window sill or adjacent window frame structure, requiring installation of brackets in the structure, and thereby either restricting the raising or lowering of the shade, or requiring manual adjustment of the bracket fixture each time the shade is raised or lowered. Furthermore, installation of some brackets may be inconvenient in metal-framed windows. Other forms of brackets may be unattractive. Thus, there exists a need for a system operable to reduce the noise and impact created by a swinging window shade that overcomes such disadvantages.

### OBJECTS AND FEATURES OF THE INVENTION

A primary object and feature of the present invention is to provide a system for reducing the sound in a room resulting from a window shade having a bottomrail swinging into and impacting the surrounding window structure.

It is a further object and feature of the present invention to provide such a system which reduces the structural impact of such a bottomrail on adjacent structures, thus preventing marring, scraping, and scratching of the surrounding structures.

A further primary object and feature of the present invention is to provide such a system that is efficient, inexpensive, easy to install and handy.

Other objects and features of this invention will become apparent with reference to the following descriptions.

### SUMMARY OF THE INVENTION

In accordance with a preferred embodiment hereof, this invention provides a window shade sound-attenuation system comprising: shade means, comprising at least one bottomrail bar having at least one window-facing side, at least one room-interior-facing side, at least one length and at least two ends, for shading at least one window comprising window structures; and sound-attenuating cushion means for cushioning such at least one bottomrail bar in a sound-attenuating manner with respect to potential impacts of such at least one bottomrail bar with at least one of such window structures; wherein such sound-attenuating cushion means comprises at least one first material strip attached to such window-facing side along such at least one length of such at least one bottomrail bar.

Moreover, it provides such a window shade sound-attenuation system wherein such sound-attenuating cushion means further comprises at least one second material strip attached to at least one of such at least two ends. Additionally, it provides such a window shade sound-attenuation system, further comprising at least one adjustment means for adjusting such sound-attenuating cushion means to fit such at least one length of such at least one bottomrail bar. Also, it provides such a window shade sound-attenuation system, wherein such sound-attenuating cushioning means further comprises at least one backing means for adding support to such sound-attenuating cushioning means. In addition, it provides such a window shade sound-attenuation system further comprising: at least one friction-fit channel attachable to such at least one bottomrail bar; wherein such at least one friction-fit channel comprises such at least one backing means. And, it provides such a window shade sound-attenuation system further comprising such at least one backing means adhesively attached to such at least one bottomrail bar. Further, it provides such a window shade sound-attenuation system further comprising at least one fastener means for fastening such at least one backing means to such at least one bottomrail bar. Even further, it provides such a window shade sound-attenuation system wherein such fastener means comprises at least one screw. Moreover, it provides such a window shade sound-attenuation system further comprising at least one locator means for locating such sound-attenuation cushion means relative to such at least one bottomrail bar during installation, wherein such at least one bottomrail bar is cushioned from impacting at least one of such window structures.

In accordance with another preferred embodiment hereof, this invention provides a window shade sound-attenuation system comprising: at least one shade, comprising at least one bottomrail bar having at least one window-facing side, at least one room-interior-facing side, at least one length and at least two ends, structured and arranged to shade at least one window comprising window structures; at least one sound-attenuating cushion structured and arranged to cushion such at least one bottomrail bar in a sound-attenuating manner with respect to potential impacts of such at least one bottomrail bar with at least one of such window structures; and at least one first material strip structured and arranged to attach to such window-facing side along such at least one length of such at least one bottomrail bar.

Additionally, it provides such a window shade sound-attenuation system, wherein such sound-attenuating cushion further comprises at least one second material strip structured and arranged to attach to at least one of such at least two ends. Also, it provides such a window shade sound-attenuation system, wherein such sound-attenuating cushion further comprises at least one backing structured and arranged to add support to such at least one cushion. In addition, it provides such a window shade sound-attenuation system, comprising at least one friction-fit channel structured and arranged to be attachable to such at least one bottomrail bar, wherein such at least one friction-fit channel comprises such backing. And, it provides such a window shade sound-attenuation system, comprising at least one adhesive attachment structured and arranged to attach to such at least one bottomrail bar, wherein such at least one backing is attached to such at least one adhesive attachment. Further, it provides such a window shade sound-attenuation system, comprising at least one fastener structured and arranged to fasten such at least one backing to such at least one bottomrail bar. Even further, it provides such a window shade sound-attenuation system, wherein such fastener comprises at least one screw. Even further, it provides such a window shade sound-attenuation system further comprising at least one locating guide structured and arranged to guide installation location of such at least one cushion relative to such at least one bottomrail bar during installation.

In accordance with another preferred embodiment hereof, this invention provides a consumer kit for at least one sound-attenuation system for a window shade comprising at least one bottomrail bar, wherein the sound-attenuation system provides cushion means for cushioning the at least one bottomrail bar in a sound-attenuating manner with respect to potential impacts of the at least one bottomrail bar with at least one adjacent window structure, wherein such consumer kit comprises: kit contents; and at least one consumer packaging material packaging such kit contents; wherein such consumer packaging material comprises indicia indicating at least one specific shade type and size-range; wherein such contents comprise at least one attachable backing, at least one attachable cushion, at least one locating guide, at least one set of instructions for installation of the sound-attenuation system, and an excess of such at least one attachable backing and such at least one attachable cushion sufficient to allow consumer cutting to size such at least one attachable cushion and such at least one attachable backing to fit such at least one specific shade type and size-range.

In accordance with another preferred embodiment hereof, this invention provides a business system, for distribution of consumer kits used to create window shade sound-attenuation systems, for window shades having at least one bottomrail bar, comprising: providing to window shade retailers and customers at least one first inventory listing of such consumer kits of sound-attenuating cushions adjustable in size to fit individual window shades; providing to such window shade retailers and customers at least one second inventory listing of such consumer kits of sound-attenuating cushions manufactured to fit standard-sized window shades; wherein such first inventory listing and such second inventory listing contain such consumer kits in a selection of finishes which will match standard window shade finishes; providing to such window shade retailers prices at which such window shade retailers may order and purchase initial stock of such consumer kits; and providing to such window shade retailers prices at which such window shade retailers may re-order and purchase additional stock of such consumer kits.

Also, this invention provides a business system, for distribution of consumer kits, used to create window shade sound-attenuation systems, for window shades having at least one bottomrail bar, comprising: providing to manufacturers at least one second inventory listing of such consumer kits of sound-attenuating cushions, manufactured to fit standard-sized window shades; providing to such manufacturers a method of matching finishes of such consumer kits to finishes of the window shades upon which such consumer kits are to be installed; providing to such manufacturers prices at which such manufacturers may order and purchase initial stock of such consumer kits; and providing to such manufacturers prices at which such manufacturers may re-order and purchase additional stock of such consumer kits.

### BRIEF DESCRIPTION OF THE DRAWINGS

FIG. 1 is a perspective view illustrating the sound-attenuating cushion, the window shade, and their relationship to the window frame according to a preferred embodiment of the present invention.

FIG. 2 is a partially exploded view illustrating how the sound-attenuating cushion is installed on an end portion and a middle portion of the bottomrail of the window shade according to the preferred embodiment of FIG. 1.

FIG. 3 is a perspective view illustrating how the sound-attenuating cushion appears once installed on the bottomrail of the window shade according to the preferred embodiment of FIG. 1.

FIG. 4 is a sectional view through the section 4-4 of FIG. 3 illustrating the attachment of the backing means to the bottomrail according to one preferred embodiment of FIG. 3.

FIG. 5 is a sectional view through the section 4-4 of FIG. 4 illustrating the attachment of the backing means to the bottomrail according to another preferred embodiment of FIG. 3.

FIG. 6 illustrates a consumer kit of the present invention.

FIG. 7 illustrates a retail distribution system for consumer kits according to a preferred business method of the present invention.

FIG. 8 illustrates an alternate retail distribution system for consumer kits according to a preferred business method of the present invention.

### DETAILED DESCRIPTION OF THE BEST MODE AND PREFERRED EMBODIMENTS OF THE INVENTION

Reference is now made to the drawings.

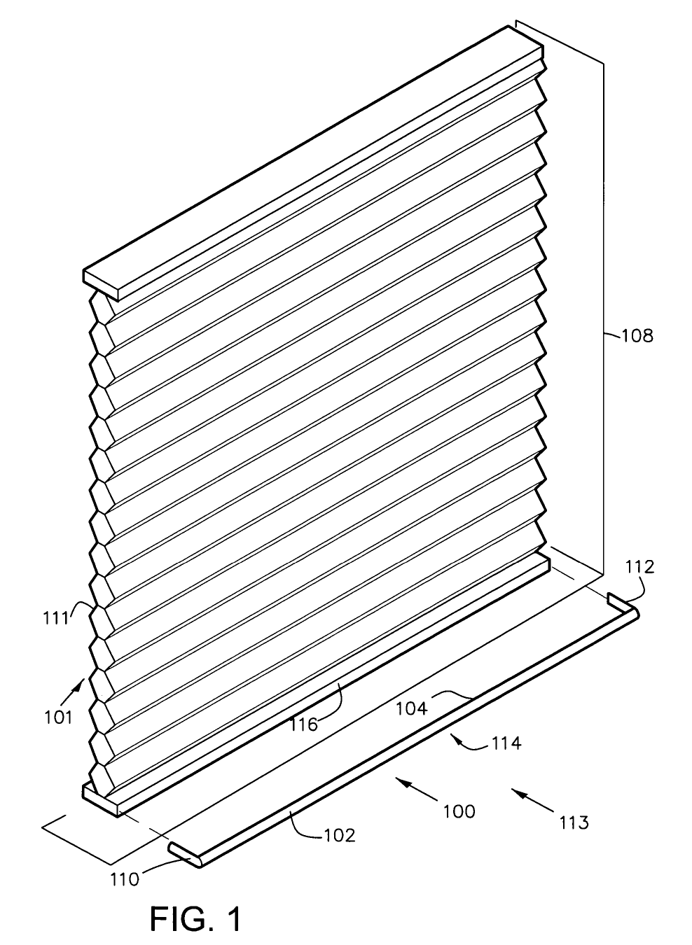

FIG. 1 illustrates the sound-attenuation system 113 of this invention according to a preferred embodiment thereof. For example, FIG. 1 illustrates how the sound-attenuation system 113 comprises a sound-attenuating cushion system 100, which attaches to the bottomrail 116 of a window shade 101. In this example, the window shade 101 is a cellular-type shade 111, as shown. Upon reading this specification, it will be understood by those of skill in the art that, under appropriate circumstances, such as user preference, alternate uses, etc., other types of window shades, such as horizontal blinds, Venetian blinds, roll-up shades, etc., may suffice.

Typically, a window shade 101 is subject to motion when swung by winds; and a window shade 101 attached to a door may also be swung by motion of the door. Preferably, the sound-attenuating cushion system 100 is adjustable in length to fit various-sized window shade(s) 101, as shown (herein embodying at least one adjustment means for adjusting such sound-attenuating cushion means to fit such at least one length of such at least one bottomrail bar). The sound-attenuating cushion system 100 provides both a passive method of quieting window shade(s) 101 and a passive method of reducing impact of a bottomrail 116 against adjacent window structures (such as window panes and window frame(s) 108) while not restricting the position of the shade. In the present invention, the term “passive” means that no manipulation or adjustment of the sound-attenuating cushion system 100 is required when raising or lowering the window shade 101 once the sound-attenuating cushion system 100 has been installed.

According to the preferred embodiment of FIG. 1, the sound-attenuation system 113 consists of a window shade 101, and a first end portion 110, a second end portion 112, and a middle portion 114 (of the sound-attenuating cushion system 100) which are attached to the ends, window-facing side, and room-interior-facing side of a bottomrail 116, as shown (herein embodying shade means, comprising at least one bottomrail bar having at least one window-facing side, at least one room-interior-facing side, at least one length and at least two ends, for shading at least one window comprising window structures; and also embodying herein at least one shade, comprising at least one bottomrail bar having at least one window-facing side, at least one room-interior-facing side, at least one length and at least two ends, structured and arranged to shade at least one window comprising window structures).

Preferably, the sound-attenuating cushion system 100 consists of a cushion material 102 (herein embodying sound-attenuating cushion means for cushioning such at least one bottomrail bar in a sound-attenuating manner with respect to potential impacts of such at least one bottomrail bar with at least one of such window structures; and also embodying herein at least one sound-attenuating cushion structured and arranged to cushion such at least one bottomrail bar in a sound-attenuating manner with respect to potential impacts of such at least one bottomrail bar with at least one of such window structures) affixed to a backing material 104, as shown, which supports the cushion material 102 (herein embodying wherein such sound-attenuating cushioning means further comprises at least one backing means for adding support to such sound-attenuating cushioning means; and also embodying herein wherein such sound-attenuating cushion further comprises at least one backing structured and arranged to add support to such at least one cushion).

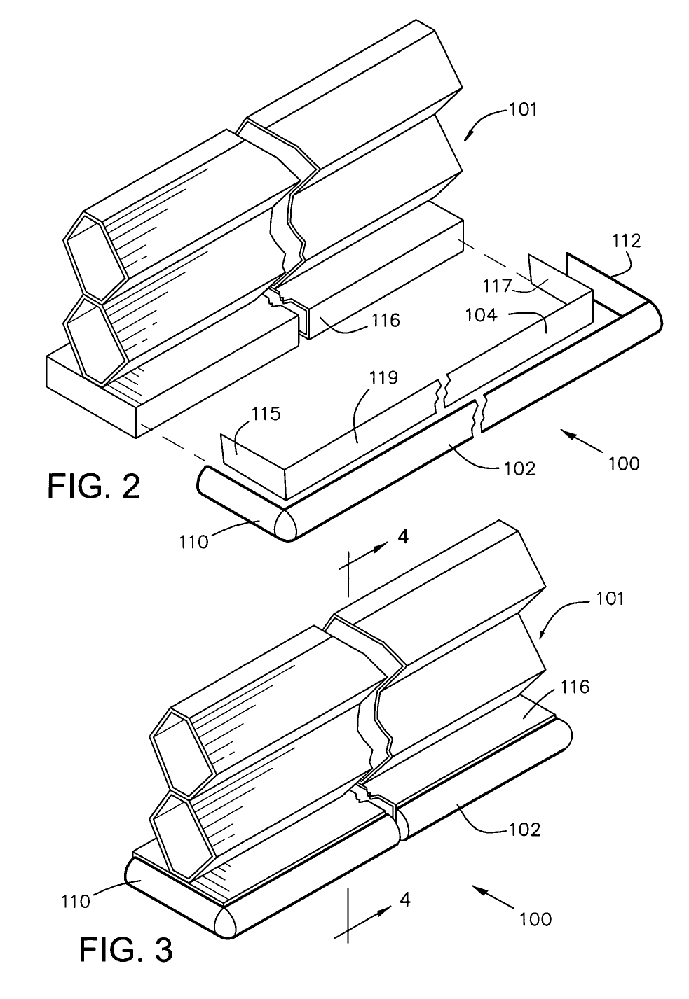

FIGS. 2 and 3 illustrate how the sound-attenuating cushion system 100 is installed on two end portions and a window-facing side of the bottomrail 116, as shown. According to one preferred embodiment, the backing material 104 preferably consists of a first end portion 115, a second end portion 117, and a middle portion 119, as shown in FIG. 2. Preferably, the first end portion 115 and second end portion 117 of the backing material 104 are attached to the ends of the bottomrail 116, as shown (herein embodying wherein such sound-attenuating cushion means comprises at least one first material strip attached to such window-facing side along such at least one length of such at least one bottomrail bar; and also embodying herein wherein such sound-attenuating cushion further comprises at least one second material strip structured and arranged to attach to at least one of such at least two ends). Preferably, the middle portion 119 of the backing material 104 is attached to the side of the bottomrail 116 adjacent the window and is cut to an appropriate length (herein embodying wherein such sound-attenuating cushion means comprises at least one first material strip attached to such window-facing side along such at least one length of such at least one bottomrail bar; and also embodying herein at least one first material strip structured and arranged to attach to such window-facing side along such at least one length of such at least one bottomrail bar). Under appropriate circumstances, other arrangements may suffice. Preferably, an excess of backing material 104 is provided such that the installer may adjust the sound-attenuating cushion system 100 by measuring, cutting and fitting the backing material 104 to a specific shade application. Those with ordinary skill in the art, upon reading this specification, will understand that, under appropriate circumstances, other methods of adjusting the sound-attenuating cushion system 100 to fit the bottomrail 116 may suffice.

FIG. 3 shows the sound attenuating cushion system 100 installed on a bottomrail 116. Under appropriate circumstances, first end portion 110, second end portion 112, and middle portion 114 may be comprised of one continuous length of sound attenuating cushion system 100.

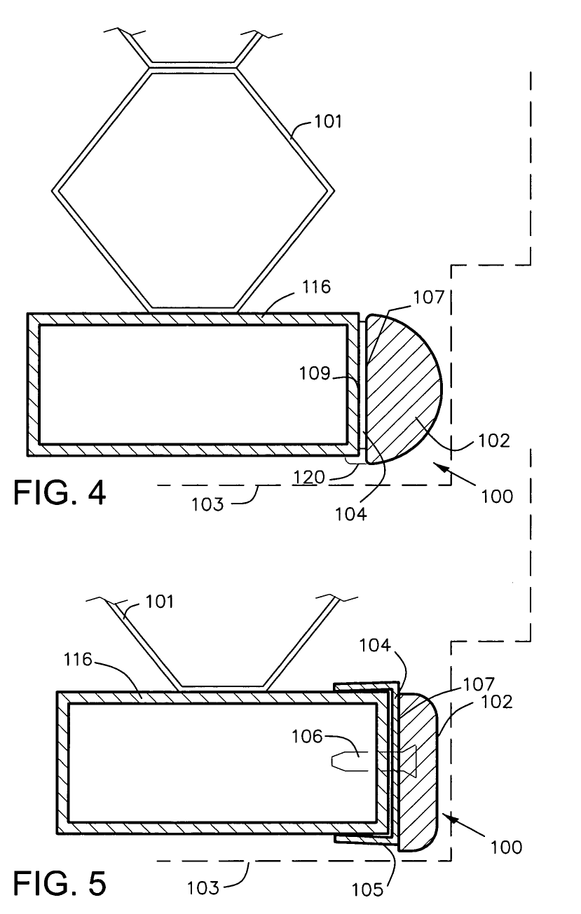

FIGS. 4 and 5 show that, preferably, the backing material 104 is affixed to at least one side of the bottomrail 116 by a means selected from the following group: a friction-fit channel 105 (herein embodying at least one friction-fit channel attachable to such at least one bottomrail bar; and also embodying herein wherein such at least one friction-fit channel comprises such at least one backing means; and also embodying herein at least one friction-fit channel structured and arranged to be attachable to such at least one bottomrail bar, wherein such at least one friction-fit channel comprises such backing); fasteners 106 (herein embodying at least one fastener means for fastening such at least one backing means to such at least one bottomrail bar; and also embodying herein wherein such fastener means comprises at least one screw; and also embodying herein at least one fastener structured and arranged to fasten such at least one backing to such at least one bottomrail bar; and also embodying herein wherein such fastener comprises at least one screw); or an adhesive strip 107 (herein embodying such at least one backing means being adhesively attached to such at least one bottomrail bar; and also embodying herein at least one adhesive attachment being structured and arranged to attach to such at least one bottomrail bar, wherein such at least one backing is attached to such at least one adhesive attachment). As shown in FIG. 4, preferably, a guide 120 is affixed to the backing material 104 when the backing material 104 is attached to the bottomrail 116 by fasteners 106 or by adhesive strip 107, so as to properly locate the cushion material 102 relative to the bottomrail 116 (herein embodying at least one locator means for locating such sound-attenuation cushion means relative to such at least one bottomrail bar during installation; and also embodying herein one locating guide structured and arranged to guide installation location of such at least one cushion relative to such at least one bottomrail bar during installation). Preferably, the guide 120 is integrally formed with the backing material 104 or, under appropriate circumstances, may be formed integrally as part of the cushion material 102. Preferably, the cushion material 102 is cut to size such that the cushion material 102 is long enough to cover the first end portion 115, the second end portion 117, and the middle portion 119 of the backing material 104 (as shown in FIG. 3). Preferably, the cushion material 102 is affixed to the backing material 104 by a means selected from the following group: an adhesive strip 109; or thermal bonding. Preferably, the cushion material 102 extends below the bottomrail 116 slightly so as to prevent contact of the bottomrail 116 on the window sill 103 (herein embodying wherein such at least one bottomrail bar is cushioned from impacting at least one of such window structures), as shown in FIGS. 4 and 5.

Preferably, the backing material 104 is a light-weight, rigid material, most preferably plastic. Under appropriate circumstances, other materials may suffice. Preferably, the backing material 104 may consist of a single or double-sided adhesive tape used to adhere the cushion material 102 directly to the bottomrail 116. Under appropriate circumstances, such as technology and/or materials improvements and/or economic need, backing material 104 may comprise adhesive used to adhere the cushion material 102 directly to the bottomrail 116.

Most preferably, the cushion material 102 is selected from the following group: polyurethane foam; rubber; or a combination of both. Upon reading this specification, it will be understood by those of skill in the art that, under appropriate circumstances, such as user preference, available materials, aesthetic considerations, etc., other impact-absorbing, resilient materials, such as silicone rubber, soft plastic, polyethylene foam, polypropylene foam, etc., may suffice.

Preferably, the overall thicknesses of the first end portion 115 and the second end portion 117 are not more than about ⅛″ (+/−3 mm) to allow adequate side clearance between the bottomrail 116 and the surrounding window frame.

Preferably, the sound-attenuating cushion system 100 may be manufactured in a variety of finishes, matching the standard window shade finishes made by major manufacturers of window shade(s) 101 (herein embodying wherein such first inventory listing and such second inventory listing contains such consumer kits in a selection of finishes which will match standard window shade finishes). According to a preferred embodiment of the present invention, the finish of the sound-attenuating cushion system 100 is selected from one of the manufactured finishes that matches the finish of the window shade 101 on which it is to be installed. The finish of a window shade is commonly a smooth painted, coated, or enameled color. Upon reading this specification, it will be understood by those with skill in the art that, under appropriate circumstances, such as user preference, aesthetic considerations, etc., other decorative finishes, such as woodgrain, transparent, textured, etc., may suffice.

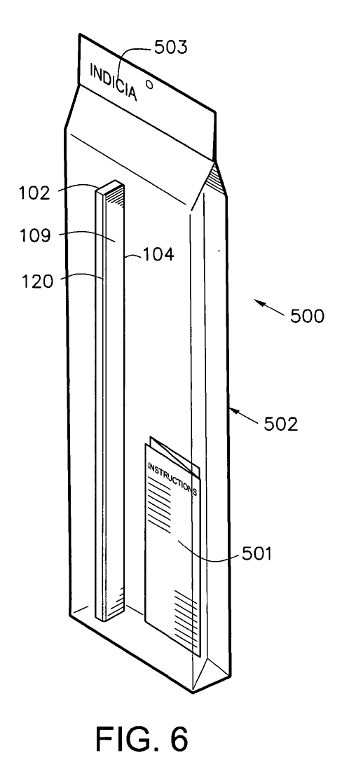

FIG. 6 illustrates a consumer kit 500. Preferably, the sound-attenuating cushion system 100 is sold as a consumer kit 500 consisting of an excess of attachable backing 104, a locating guide 120, an excess length of attachable cushion material 102, a set of instructions 501, and consumer packaging material 502 comprising indicia 503 (embodying herein kit contents; and at least one consumer packaging material packaging such kit contents; wherein such consumer packaging material comprises indicia indicating at least one specific shade type and size-range; wherein such contents comprise at least one attachable backing, at least one attachable cushion, at least one locating guide, at least one set of instructions for installation of the sound-attenuation system, and an excess of such at least one attachable backing and such at least one attachable cushion sufficient to allow consumer cutting to size such at least one attachable cushion and such at least one attachable backing to fit such at least one specific shade type and size-range). Under appropriate circumstances, indicia 503 may comprise instructions 501.

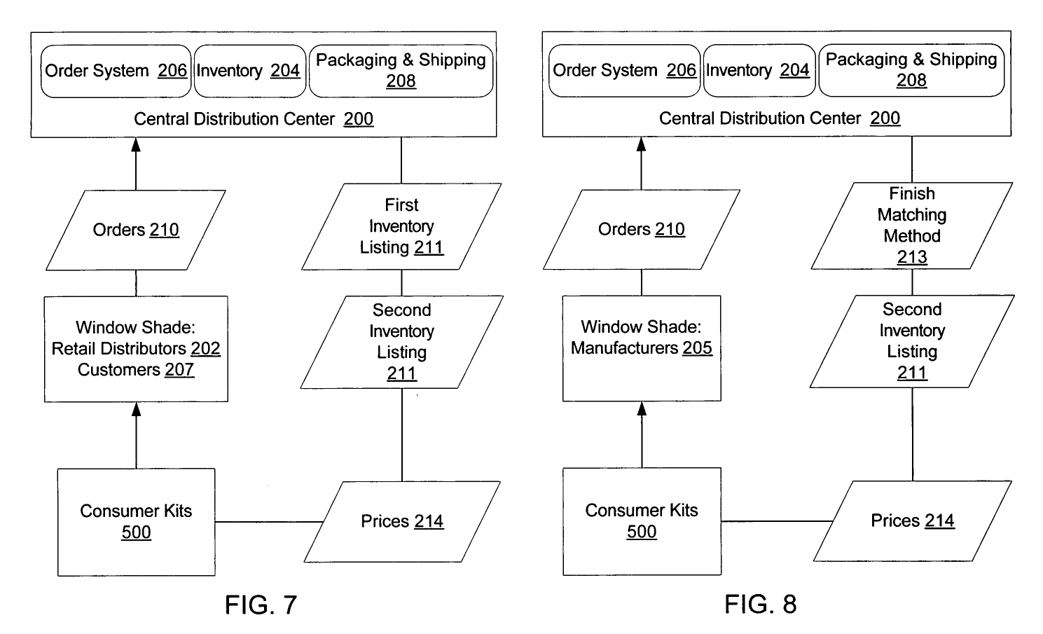

FIG. 7 illustrates an example of a retail distribution system 700 for a sound-attenuating cushion system(s) 100, according to a preferred business method of the present invention. Preferably, the sound-attenuating cushion system 100 is sold through a network of retail distributors 202. A central distribution center 200 preferably provides a ready-to-ship inventory 204, a product ordering system 206, and packaging/shipping component 208, as shown. The ready-to-ship inventory 204 consists of a sound-attenuating cushion system(s) 100 packaged into a consumer kit(s) 500, which is either adjustable in size to fit an individual window shade 101, or manufactured to fit a standard-sized window shade 101, or both (embodying herein providing to window shade retailers and customers at least one first inventory listing of such consumer kits of sound-attenuating cushions adjustable in size to fit individual window shades; and also embodying herein providing to such window shade retailers and customers at least one second inventory listing of such consumer kits of sound-attenuating cushions manufactured to fit standard-sized window shades; and also embodying herein providing to manufacturers such at least one second inventory listing of such consumer kits of sound-attenuating cushions, manufactured to fit standard-sized window shades).

Preferably, the central distribution center 200 provides retail distributors 202 or customers 207 with an inventory listing of the available consumer kits 500. Most preferably, the inventory listing may be published, via the Internet, or by printed catalog. Preferably, the inventory describes at least the price 214, finish, attachment method, and size of the sound attenuating cushion system(s) 100 contained in consumer kits 500. The inventory listing may preferably be a first inventory listing 211 of consumer kits 500 of sound-attenuating cushions 100 adjustable in size to fit individual window shades, and/or a second inventory listing 212 of consumer kits 500 of sound-attenuating cushions 100 manufactured to fit standard-sized window shades. Under appropriate circumstances, first inventory listing 211 and second inventory listing 212 may be combined into one inventory listing. Under appropriate circumstances, other inventory distribution methods may be used.

Preferably, prices 214 to the retail distributors 202 or customers 207 are established and provided through the distribution representative, through published lists, in first inventory listing 211, or in second inventory listing 212. (embodying herein providing to such window shade retailers prices at which such window shade retailers may order and purchase initial stock of such consumer kits; and also embodying providing to such window shade retailers prices at which such window shade retailers may re-order and purchase additional stock of such consumer kits). Retail distributors 202 or customers 207 may then place orders 210.

FIG. 8 illustrates an example of a retail distribution system 800 for consumer kits 500, according to an alternate preferred business method of the present invention. Manufacturers 205 first order 210, and are preferably sold, a stock of consumer kits 500, preferably from the second inventory list 212 with prices 214 (embodying herein providing to said manufacturers prices at which said manufacturers may order and purchase initial stock of such consumer kits; and providing to said manufacturers prices at which said manufacturers may re-order and purchase additional stock of such consumer kits). Preferably, instructions 501 and proper finish matching methods 213 are also provided (embodying herein providing to such manufacturers a method of matching finishes of such consumer kits to finishes of the window shades upon which such consumer kits are to be installed).

Under appropriate circumstances, sound-attenuating cushion systems 100 may be sold directly to manufacturers 205, preferably with instructions 501, without being packaged into consumer kits 500.

Preferably, training is self-directed and is provided as instructions 501 on media such as compact disks or instruction packets. Under appropriate circumstances, other training methods may be used.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A window shade sound-attenuation system comprising:
a) shade means, comprising at least one bottomrail bar having at least one window-facing side, at least one room-interior-facing side, at least one length and at least two ends, for shading at least one window comprising window structures; and
b) sound-attenuating cushion means for cushioning said at least one bottomrail bar in a sound-attenuating manner with respect to potential impacts of said at least one bottomrail bar with at least one of said window structures;
c) wherein said sound-attenuating cushion means comprises at least one first material strip attached to said window-facing side along said at least one length of said at least one bottomrail bar.

2) The window shade sound-attenuation system according to claim 1 wherein said sound-attenuating cushion means further comprises at least one second material strip attached to at least one of said at least two ends.

3) The window shade sound-attenuation system according to claim 1, further comprising at least one adjustment means for adjusting said sound-attenuating cushion means to fit said at least one length of said at least one bottomrail bar.

4) The window shade sound-attenuation system according to claim 1, wherein said sound-attenuating cushioning means further comprises at least one backing means for adding support to said sound-attenuating cushioning means.

5) The window shade sound-attenuation system according to claim 4 further comprising:
a) at least one friction-fit channel attachable to said at least one bottomrail bar;
b) wherein said at least one friction-fit channel comprises said at least one backing means.

6) The window shade sound-attenuation system according to claim 4 further comprising said at least one backing means adhesively attached to said at least one bottomrail bar.

7) The window shade sound-attenuation system according to claim 4 further comprising at least one fastener means for fastening said at least one backing means to said at least one bottomrail bar.

8) The window shade sound-attenuation system according to claim 7 wherein said fastener means comprises at least one screw.

9) The window shade sound-attenuation system according to claim 1 further comprising at least one locator means for locating said sound-attenuation cushion means relative to said at least one bottomrail bar during installation, wherein said at least one bottomrail bar is cushioned from impacting at least one of said window structures.

10) A window shade sound-attenuation system comprising:
a) at least one shade, comprising at least one bottomrail bar having at least one window-facing side, at least one room-interior-facing side, at least one length and at least two ends, structured and arranged to shade at least one window comprising window structures;
b) at least one sound-attenuating cushion structured and arranged to cushion said at least one bottomrail bar in a sound-attenuating manner with respect to potential impacts of said at least one bottomrail bar with at least one of said window structures; and
c) at least one first material strip structured and arranged to attach to said window-facing side along said at least one length of said at least one bottomrail bar.

11) The window shade sound-attenuation system according to claim 10, wherein said sound-attenuating cushion further comprises at least one second material strip structured and arranged to attach to at least one of said at least two ends.

12) The window shade sound-attenuation system according to claim 10, wherein said sound-attenuating cushion further comprises at least one backing structured and arranged to add support said at least one cushion.

13) The window shade sound-attenuation system according to claim 12, comprising at least one friction-fit channel structured and arranged to be attachable to said at least one bottomrail bar, wherein said at least one friction-fit channel comprises said at least one backing.

14) The window shade sound-attenuation system according to claim 12, comprising at least one adhesive attachment structured and arranged to attach to said at least one bottomrail bar, wherein said at least one backing is attached to said at least one adhesive attachment.

15) The window shade sound-attenuation system according to claim 12, comprising at least one fastener structured and arranged to fasten said at least one backing to said at least one bottomrail bar.

16) The window shade sound-attenuation system according to claim 15, wherein said fastener comprises at least one screw.

17) The window shade sound-attenuation system according to claim 10 further comprising at least one locating guide structured and arranged to guide installation location of said at least one cushion relative to said at least one bottomrail bar during installation.

18) A consumer kit for at least one sound-attenuation system for a window shade comprising at least one bottomrail bar, wherein the sound-attenuation system provides cushion means for cushioning the at least one bottomrail bar in a sound-attenuating manner with respect to potential impacts of the at least one bottomrail bar with at least one adjacent window structure, wherein said consumer kit comprises:
a) kit contents; and
b) at least one consumer packaging material packaging said kit contents;
c) wherein said consumer packaging material comprises indicia indicating at least one specific shade type and size-range;
d) wherein said contents comprise
i) at least one attachable backing,
ii) at least one attachable cushion,
iii) at least one locating guide,
iv) at least one set of instructions for installation of the sound-attenuation system, and
v) an excess of said at least one attachable backing and said at least one attachable cushion sufficient to allow consumer cutting to size said at least one attachable cushion and said at least one attachable backing to fit said at least one specific shade type and size-range.

19) A business system, for distribution of consumer kits, used to create window shade sound-attenuation systems, for window shades having at least one bottomrail bar, comprising:
a) providing to window shade retailers and customers at least one first inventory listing of such consumer kits of sound-attenuating cushions adjustable in size to fit individual window shades;
b) providing to said window shade retailers and customers at least one second inventory listing of such consumer kits of sound-attenuating cushions manufactured to fit standard-sized window shades;
c) wherein said first inventory listing and said second inventory listing contain such consumer kits in a selection of finishes which will match standard window shade finishes;
d) providing to said window shade retailers prices at which said window shade retailers may order and purchase initial stock of such consumer kits; and
e) providing to said window shade retailers prices at which said window shade retailers may re-order and purchase additional stock of such consumer kits.

20) A business system, for distribution of consumer kits, used to create window shade sound-attenuation systems, for window shades having at least one bottomrail bar, comprising:
a) providing to manufacturers at least one second inventory listing of such consumer kits of sound-attenuating cushions, manufactured to fit standard-sized window shades;
b) providing to said manufacturers a method of matching finishes of such consumer kits to finishes of the window shades upon which such consumer kits are to be installed;
c) providing to said manufacturers prices at which said manufacturers may order and purchase initial stock of such consumer kits; and
d) providing to said manufacturers prices at which said manufacturers may re-order and purchase additional stock of such consumer kits.
